(19) United States
(12) Patent Application Publication
(10) Pub. No.: US 2013/0169877 A1
(43) Pub. Date: Jul. 4, 2013

(54) SUPPLEMENTAL AUDIO AND VISUAL SYSTEM FOR A VIDEO DISPLAY

(71) Applicant: Huong THI DANG, WEST BABYLON, NY (US)

(72) Inventor: Huong THI DANG, WEST BABYLON, NY (US)

(21) Appl. No.: 13/343,575

(22) Filed: Jan. 4, 2012

(51) Int. Cl. H04N 5/45

(52) U.S. Cl. 348/565; 348/E05.112

(57) ABSTRACT

There is disclosed a video display device comprising a video display, and a first video driver for controlling an image on the video display. There is also a second video driver for controlling a separate image on the video display wherein the second video driver is configured to present a different video image on the video display than the first video driver. There is also at least one audio transcriber, having an output in communication with the second video driver. The audio transcriber comprises at least one input for receiving an audio signal, at least one transcriber for transcribing the audio signal into an electrical signal and at least one output for outputting the electrical signal into the second video driver to create a display having images based upon the input of the audio transcriber.

### BACKGROUND OF THE INVENTION

Video displays such as flat screen video displays as well as cathode ray tube displays usually incorporate a single picture associated with a received signal to provide a video as well as an audio image. With a flat screen video display, it is generally known to have a grid which is used to excite objects to create an image on a screen based upon different pixels distributed about the screen. Some screens which adapt to audio signals have been known in the art. For example, U.S. Pat. No. 4,167,752 to Liebler et al, which issued on Sep. 11, 1979, the disclosure of which is hereby incorporated by reference discloses a color video display for audio signals.

However what is not known is having a separate video systems separate from a standard received video system which operates independent of the received signal which is configured to interact with audio signals as well as a system which is configured to store audio files such as music songs for creating a separate audio/visual experience for a user.

### SUMMARY OF THE INVENTION

At least one embodiment of the invention relates to a video display device comprising a video display, and a first video driver for controlling an image on the video display. There is also a second video driver for controlling a separate image on the video display wherein the second video driver is configured to present a different video image on the video display than the first video driver. There is also at least one audio transcriber, having an output in communication with the second video driver. The audio transcriber comprises at least one input for receiving an audio signal, at least one transcriber element for transcribing the audio signal into an electrical signal, and at least one output for outputting the electrical signal into the second video driver to create a display having images based upon the input of the audio transcriber.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1A shows a side cross-sectional view of a video display screen;

FIG. 1B shows a front view of a matrix for a video display screen with additional matrices included;

FIG. 2A shows a schematic block diagram of a first embodiment of a display device;

FIG. 2B shows a schematic block diagram of a second embodiment of a display device;

FIG. 2C is an exploded side perspective view of an in-laid multiple level set of matrices;

FIG. 2D is an exploded side perspective view of the screen for the matrices shown in FIG. 1B;

FIG. 3A shows a schematic block diagram of a first embodiment of an audio transcriber;

FIG. 3B shows a schematic block diagram of a second embodiment of a second embodiment of an audio transcriber;

FIG. 4A is a schematic block diagram for the second video driver;

FIG. 4B is a view of a housing for the second set of matrices;

FIG. 4C is a front view of the video screen with artwork being displayed in different zones;

FIG. 4D is a front view of the video screen with texting being displayed on the screen;

FIG. 5 shows a plan view of a remote control for use with the present invention; and

FIG. 6 shows a flowchart for controlling the system as disclosed in FIGS. 1A-5.

### DETAILED DESCRIPTION OF PREFERRED EMBODIMENTS

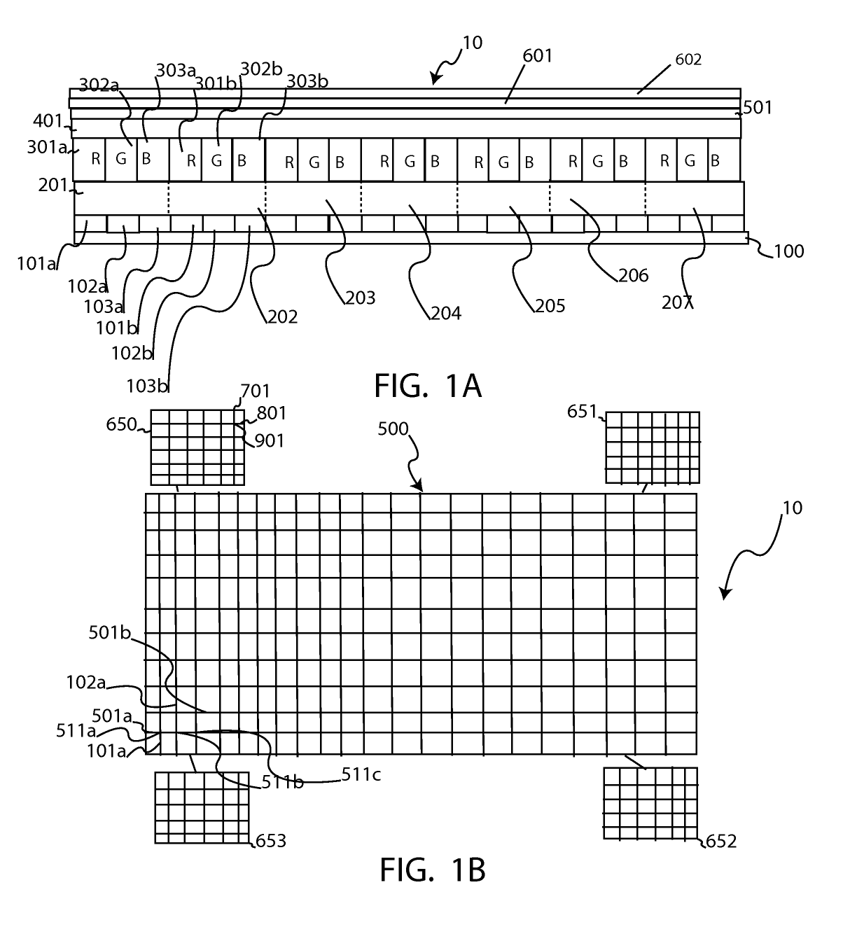

FIG. 1A shows a side cross-sectional view of a video display screen. In this view, there is shown a display screen 10, having a rear plate glass 100, a plurality of address electrodes 101a, 102a, 103a, 101b, 102b, and 103b. These different address electrodes are configured to form at least three different address electrodes for each main cell. Each main cell comprises at least three different colors which includes a red cell 301a, a green cell 302a, and a blue cell 303 a, which is divided by or separated from address electrodes by an address protective layer 201. In addition, address electrodes 101b, 102b, and 103b are separated by an address protective layer 202 which is essentially formed as a one piece layer. Each one of these address protective layer sections 201, 202, 203, 204, 205, 206, and 207 which are shown with dashed lines show the sections for main cells for an image. Each one of these main cells comprise at least three color cells such as a red color cell, a green color cell and a blue color cell. Thus, these cells combine form a single main cell capable of providing a light of any suitable color and thereby forming a pixel. In addition, disposed in front of cells 301a, 302a, and 303a is a covering layer such as a magnesium oxide layer 401. Disposed in front of magnesium oxide layer 401, is a display electrode 501. Display electrode 501 extends transverse or substantially perpendicular to address electrodes 101a, 102a, 103a, etc. As shown in FIG. 1B there is a grid or matrix formed by the intersection of address electrodes 101 intersecting with display electrodes 501. Each one of these intersections forms a display address. Disposed in front of the display electrodes, is a dielectric layer 601. In addition disposed in front of dielectric layer 601 is a front plate glass 602. This layout forms a standard layout for a flat screen display such as a plasma television. Similar designs using a grid pattern are also available for use with a LCD screen.

FIG. 1B shows a layout for the different grids formed by the intersection of address electrodes with display electrodes. For example, with display 10 there are a plurality of address electrodes 101a, 102a, and 103a, which intersect with associated display electrodes 501a, and 501b. Each one of these intersections creates a display point or address on the matrix. Each one of these addresses corresponds to an individual cell such as a red cell 301a, a green cell 302a, or a blue cell 303a. Therefore, if instructions are sent from the display controller to this grid creating electrical charge in each one of these or at particular intersection points, this then energizes each particular cell to create a color image.

For example, intersection points 511a, 511b, and 511c, form intersection points forming three different color cells such as a single main cell of display for displaying a single pixel for an image. A plurality of pixels are then used together in a group to form an image.

This configuration which is usually associated with a plasma television can also be similar to the configuration for LED displays as well as for LCD displays as well.

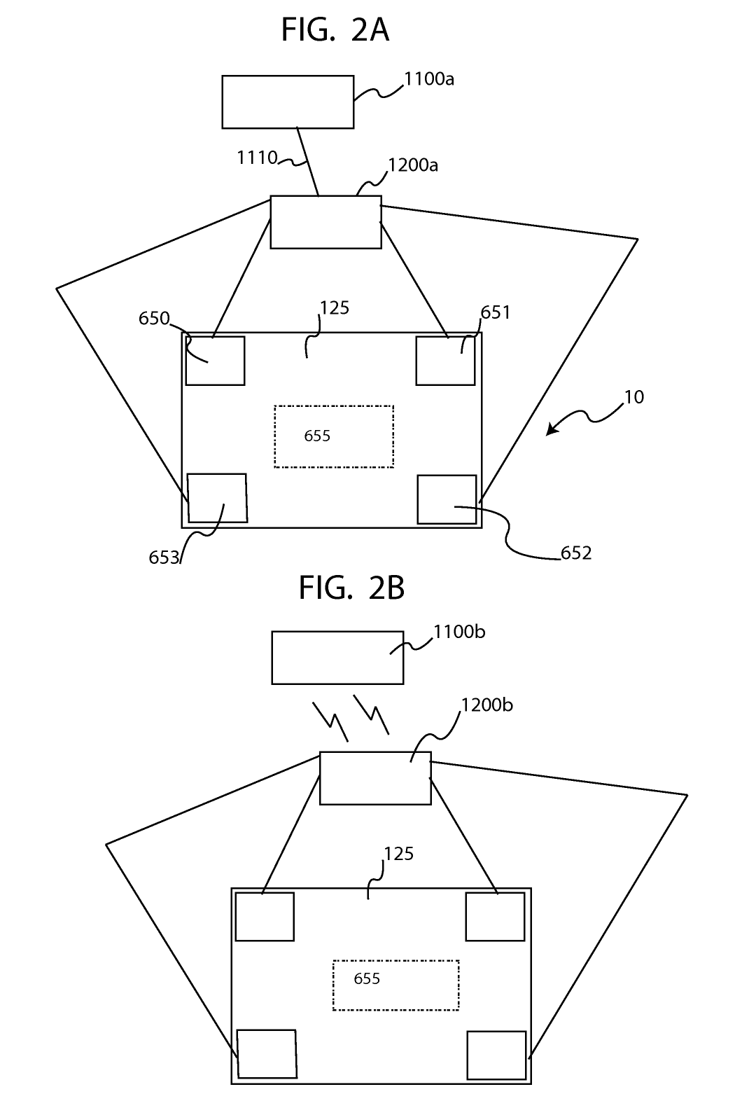

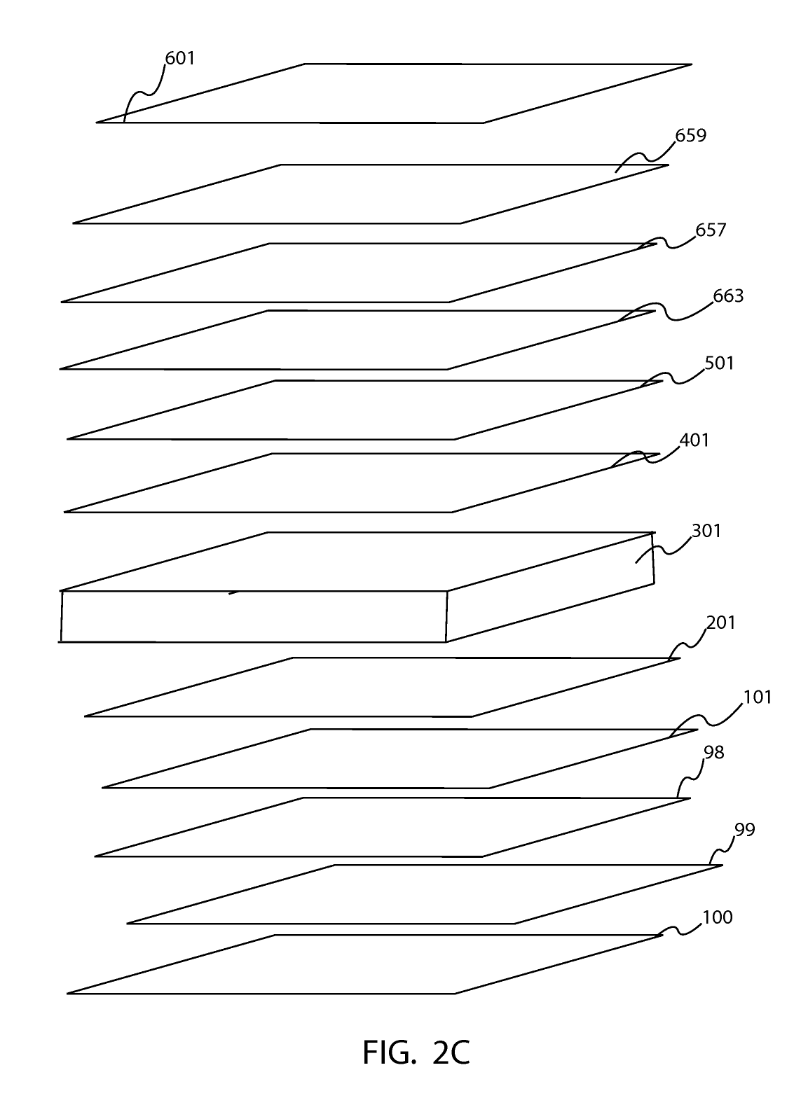

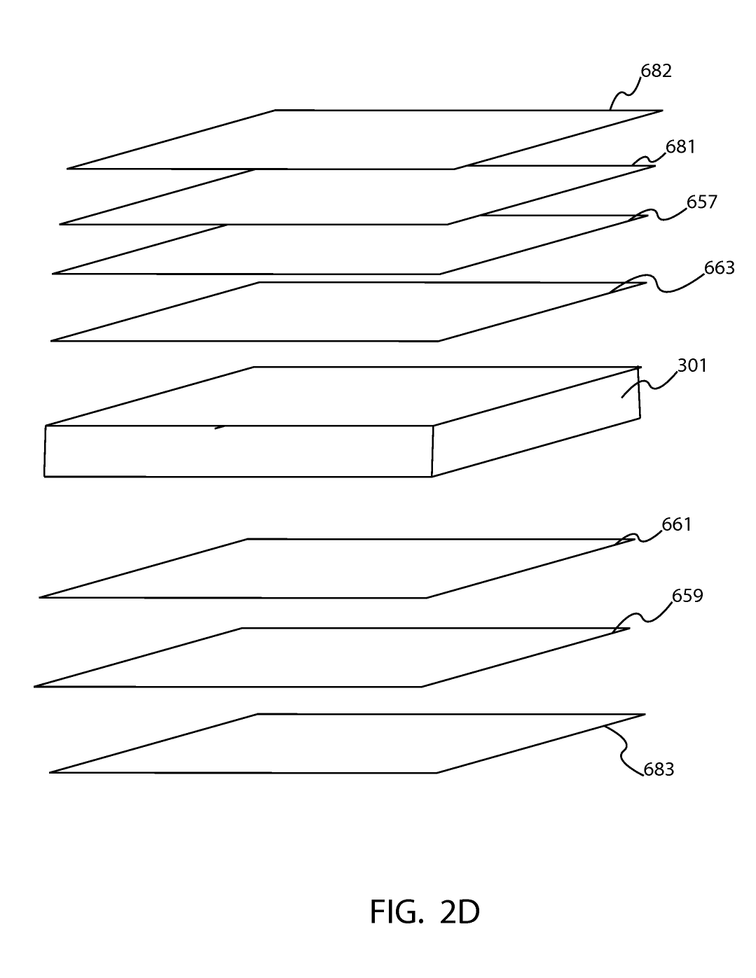

With the present embodiment as shown in FIG. 1B, there is shown five separate matrices. For example, a first matrix 500 forms the main matrix for display 10. Additional matrices 650, 651, 652, and 653 which are separate, and electrically isolated from main matrix 500 are shown in this embodiment. The separate additional matrices can then be controlled by a second display controller such a second display controller 1200a or 1200b shown in FIG. 2A. Each one of these individual matrices 650, 651, 652, and 653 contain both address electrodes, and display electrodes. For example, there is shown an address electrodes 701, a display electrode 801, and a display point or an address 901 formed by the intersection of address electrodes 701 and display electrode 801. In each of these additional matrices, a plurality of different intersection points or addresses are therefore formed by these intersection points. Therefore, as discussed above, three of these addresses then form a main cell forming a pixel. A plurality of pixels grouped together then form an image.

In one embodiment, the matrices 650, 651, 652 and 653 are formed separate from matrix 500 such as shown in FIGS. 2C and 2D. Alternatively, in another embodiment, these matrices could be incorporated as particular integrated sections of an overall matrix 500. This configuration is shown in greater detail in FIG. 2A.

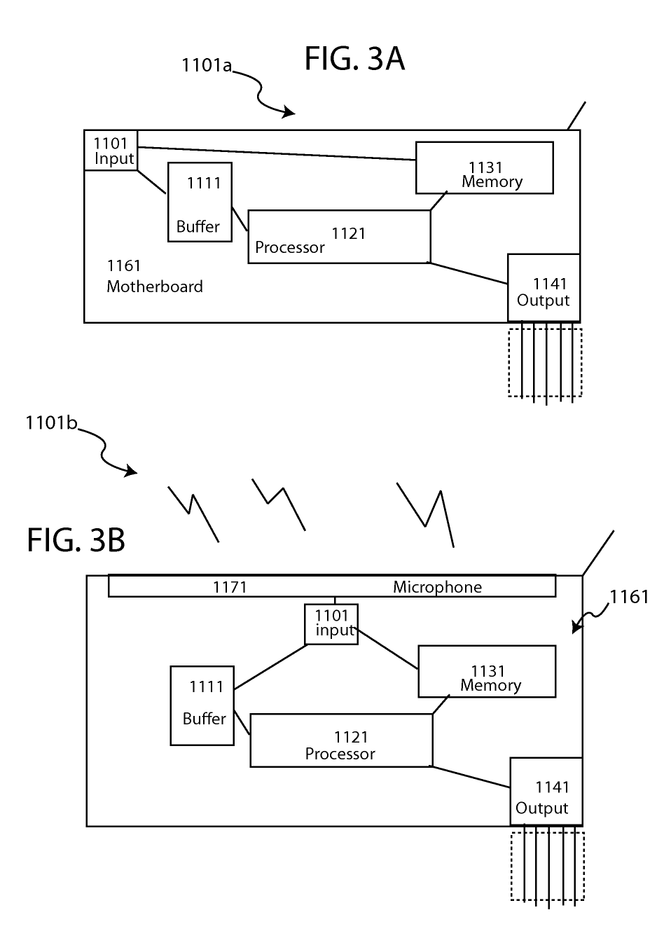

FIG. 2A shows a schematic block diagram of a first embodiment of a display device 10. With this design, there is shown a video display device comprising a video display 125. Coupled to, or in communication with the video display 125 is a first video driver 655 for controlling an image on the video display 125. There is also a second video driver 1200a or 1200b for controlling a separate image on the video display 125 wherein the second video driver is configured to present a different video image on the video display than the first video driver 655. There is also at least one audio transcriber 1100a, having an output in communication with the second video driver 1200a and 1200b. The audio transcriber 1100a comprises at least one input 1101 for receiving an audio signal, at least one transcriber or processor 1121 for transcribing the audio signal into an electrical signal, and at least one output 1141 (See FIG. 3A) for outputting the electrical signal into the second video driver to create a display having images based upon the input of the audio transcriber.

Both the first video driver 655 and the second video driver 1200a or 1200b are in communication with a plurality of video addresses 511a or 901 of at least one of the matrices 500, 650, 651, 652 653 and is configured to create a display at the plurality of video addresses. Thus, the second video display driver is configured to provide a separate image from the first video driver and act independent of the first video driver.

In at least one embodiment, such as shown in FIG. 1B and in FIG. 7A, and as well as in FIG. 2C, the second video driver 1200a, 1200b is in communication with a plurality of video addresses 901 that are separate from the plurality of video addresses such as video addresses 511a in communication with the first video driver in first matrix 500. These addresses, and consequently the associated matrices 650, 651, 652, and 653 can be isolated by a dielectric from matrix 500. For example, as shown in FIG. 2C, address electrode 701 can be overlayed adjacent to address electrode 101a, but separated by a dielectric, while display electrode 501a can be positioned adjacent to but electrically isolated from display electrode 801 thereby allowing two different matrices two operate on the same cells but in an electrically isolated manner.

In addition, in at least one embodiment, the system can be defaulted so that the second video driver controls the output in at least the region controlled by the second video driver so that the screen does not contain overlapping video instructions. Alternatively in another embodiment, the main video driver can instead be defaulted so that when the main video driver and the second video driver are sending instructions only the images from the main video driver are shown if the regions controlled by the main video driver and the second video driver overlap.

As shown in FIGS. 2A and 2B, at least one of the at least four additional video matrices 650, 651, 652, and 653 is positioned in a corner region of the video display 500.

FIG. 2C shows a perspective view of the different layers of the video display device shown in FIG. 1B. In this embodiment there is rear glass plate 100, electrode region 99 for the additional video driver, a dielectric region 98 to separate electrode region 99 from electrode region 101, address protective region 201, 202, 203, 204, 205, 206, and 207, cell region 301, layer 401, display electrode 501, dielectric or insulating layer 663, additional display matrix 657, matrix covering layer 659, and cover plate 601. With this design, the additional electrode or display regions 99 and 657 are used to excite this region but are connected to the second video driver but electrically isolated from the other display or electrode regions these separate matrices can be separately controlled by a second video driver such as second video driver 1200a or 1200b, but not associated with the first video driver 655.

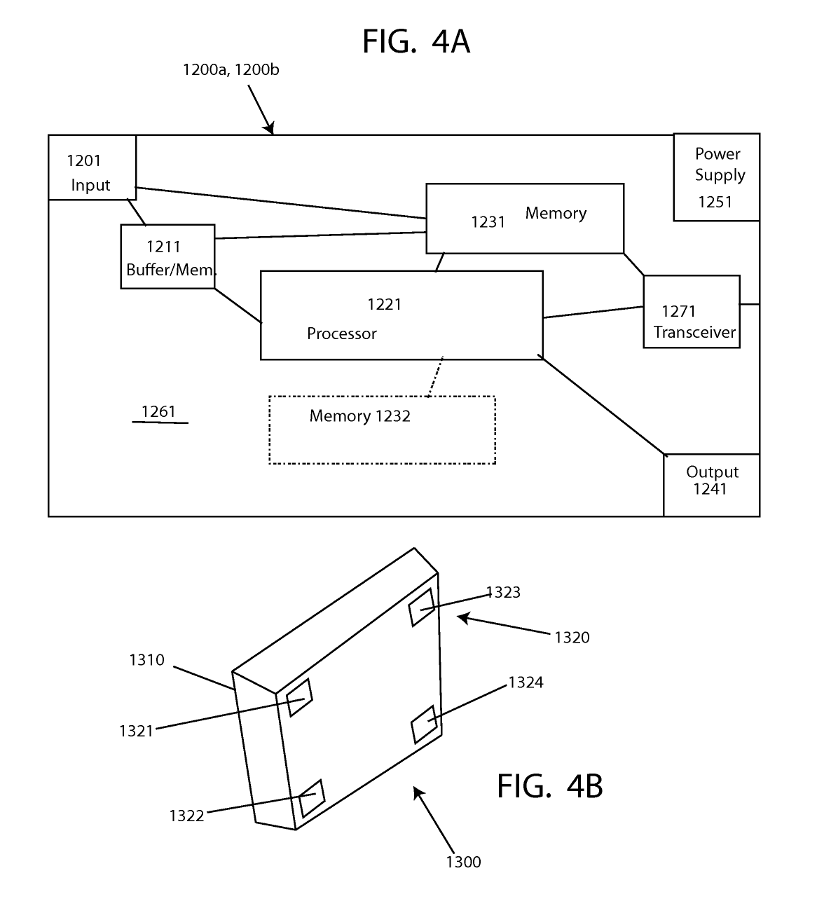

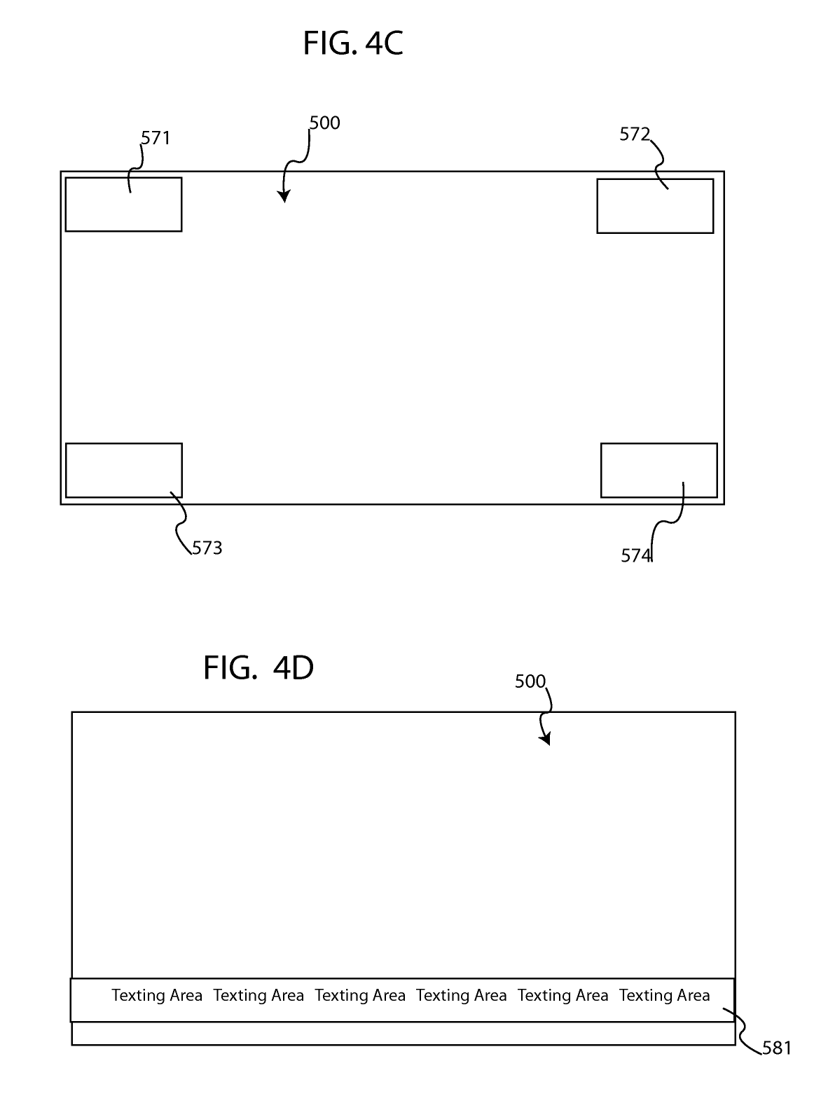

In addition FIG. 2D is a side cross-sectional view of the separate video display screen such as shown in FIG. 4B. In this view there is a dielectric backing layer 683, an electrode matrix layer 659 which is essentially similar to layer 101, a dielectric layer 661 similar to layer 201, a layer of cells 301 similar to cell layer 301 in FIGS. 2C, 1A etc. In addition there is an additional covering layer 664 similar to the layer 401 in FIG. 1A, another display matrix 657 is used similar to display electrode 501 shown in FIG. 1A. Furthermore, there are additional layers 681 and 681 similar to layers 601 and 601 shown in FIG. 1A which form a dielectric layer and a glass layer respectively. Thus, this embodiment shows that there can be essentially a separate video monitor which can be stored in an additional housing such as housing 1300 in FIG. 4B and be operated separately from a separate video driver such as second video driver 1200a or in another embodiment video driver 1200b.

Two different embodiments are shown for audio transcriber 1100a in FIGS. 3A and 3B. For example, audio transcriber 1100a comprises a microprocessor 1121, wherein microprocessor 1121 is configured to process signals received by the audio transcriber and to also retrieve audio files from memory 1201(See FIG. 4A). Audio transcriber 1101a also includes an input port 1101, an input data buffer 1111, and an additional memory 1131. Buffer 1111 has an input in communication with input port 1101 and is also in communication either directly with processor 1121 or directly in communication with a memory 1131. Processor 1121 can be in the form of a microprocessor which is configured to process audio data received from input port 1101 as well as transcribe this audio data into electrical signals that can be used to by video driver 1000a to create video images that reflect or are at least correlated with the audio signals received by audio transcriber 1100a. Memory 1131, which is in the form of a EEPROM or flash memory or any other suitable memory is configured to store the program configured to control processor 1121. In addition, this embodiment shows memory 1111 as separate from memory 1131. Memory 1131 is configured to store a program which provides instructions to microprocessor 1121 to perform at least one of the following steps: retrieving audio files for play by an audio receiver; determining an amplitude of an audio signal; determining a peak amplitude of the audio signal; determining a peak amplitude across a period of time of the audio signal; and providing an output electrical signal based upon the audio signal.

Essentially, microprocessor 1121 is configured to determine the beat of an incoming audio signal by determining the amplitude or power of the signal. By determining the amplitude or power of the signal, the beat can be determined from the audio signal. These beats can be measured by determining the peak amplitude of the signal, such as the peak amplitude over a period of time. This beat or other sub-beats can then be used to create an electrical output which is in the form of instructions to the second video driver 1200a. This output can then be transposed or transcribed by video driver 1200a into optical or visual images in the form of flashing lights symbolic of the beats.

There is also a power supply 1151 which is configured to power a motherboard 1161 which also allows all of these components to have power and to communicate with each other.

As shown in FIG. 3B, the audio transcriber 1100b is configured so that the audio input 1171 is actually a microphone 1171 which receives the audio signals into input 1101, which then sends this information into buffer 1111, and/or memory 1131. This information is then sent into processor 1121 to be processed, whereby this information is then sent out through output 1141.

FIG. 4A is a schematic block diagram of a second video driver 1200a in a first embodiment or 1200b in a second embodiment, which comprise a input port 1201, a buffer 1211, a processor 1221, which in at least one embodiment is in the form of a microprocessor, a memory 1231 and an output port 1241. There is also a power supply 1251 and a motherboard 1261 which receives power from power supply 1251 and provides power and communication capability between the other components. Second video driver 1200a or 1200b is configured to separately control the video output which is separate from first video driver 655. This second video driver can either operate using pre-recorded artistic patterns or schemes stored in memory 1231 and controlled by processor 1221 or it can receive and interpret audio signals from audio transcriber 1100a or 1100b to create a visually artistic output based upon the transcribed video input. The output for this second video driver can be coupled into an input for a video screen or into an input for the first video driver to control the first video driver in a master/slave configuration. The difference between the configuration of 1200a and 1200b is that the configuration of 1200b includes additional optional memory 1232. This additional memory 1232 can be configured as the memory to store additional songs, artistic patterns, or even to store incoming texts as disclosed below, while memory 1231 would then be used as typical RAM memory configured to allow the processor to perform multiple complicated steps.

Memory 1231 can be used to store the texting information. In addition, memory 1231 can also be used to store the random artistic layouts to be used in the display as shown in FIG. 4C as well. Alternatively a series of preprogrammed artistic schemes can be stored in memory 1231 and then displayed on display 500 as well. This system can also include a transceiver 1271, wherein this transceiver can serve as a node or an address on a network and include addressable circuitry. Transceiver 1271 can be coupled to a motherboard 1261 and in communication with memory 1231, as well as processor 1221 while receiving power from the power supply 1251. This addressable circuitry could operate on a computer network architecture such as by using bluetooth, TCP/IP protocol or any other type of communication protocol. This transceiver can be in the form of a wireless or wired transceiver. This transceiver could also be used and allow this second video driver to act as a computer type device which can be programmed to receive text messages, twitter announcements, emails, or any other type of communication. Thus, a user can contact this second video driver on a network and then update either the artistic information or store texting information in memory 1231.

FIG. 4B is as prospective view of a housing 1300 which is configured to house a display comprising any one of matrices 650, 651, 652, or 653. This housing 1300 includes a body portion 1310, and at least one coupling element 1320. In this case there is shown four coupling elements 1321, 1322, 1323, or 1324. These coupling elements can be in the form of an adhesive, a hook and loop fastener, a clamp, a cinch, a tie, or any other coupling element known in the art. With this configuration the four different displays 650, 651, 652, 653, can be housed in a separate housing from the main display and then be selectively coupled to the main display by any known way or positioned in different positions relative to the display as well.

FIG. 4C is a front view of the video screen with artwork being displayed in different zones, such as zones 571, 572, 573, or 574. For example, the artwork can be keyed or tied with the acoustic or musical sounds being sent through the system as described above, or it could be randomly or systematically displayed on screen 500 in a pattern.

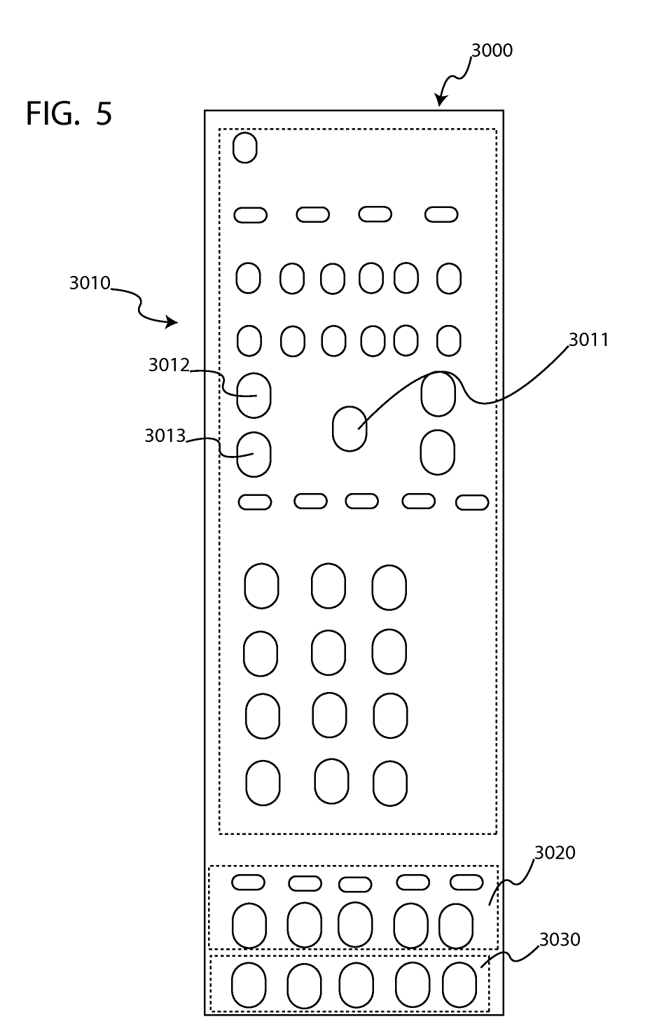

FIG. 4D is a front view of the video screen with texting being displayed on the screen 500. The texting information can be sent either using remote control 3000 (See FIG. 5) or be sent using a computer type device including but not limited to a personal computer (PC), a server, a phone, a tablet computer, a laptop, or any other type of computing means. In this case, a person using a remote control could type in a repeatable message into the remote control, and then have it transmitted locally to second video driver 1200a or 1200b. Alternatively, a person could text this information, send an email or send uploadable text information to second video driver 1200a or 1200b. This texting information can then be scrolled across screen 500 in any suitable area such as area 581.

FIG. 5 shows a plan view of a remote control 3000. The remote control 3000 is configured to control the at least one first video driver and the at least one second video driver. The remote control 3000 includes at least a first set of buttons 3010 for controlling the first video driver, at least a second set of buttons 3020 for controlling the second video driver and at least one additional button 3030 for controlling the at least one audio transcriber 1100 (See FIGS. 2A, 2B.

In at least one embodiment, first video driver 655 comprises a static flat light setting and the at least one remote control 3000 comprises at least one button, such as buttons 3012 and 3013 to control a brightness of the static flat light setting to control an illumination of light in a room. Button 3011 is an on/off button to turn on or off the static flat light setting.

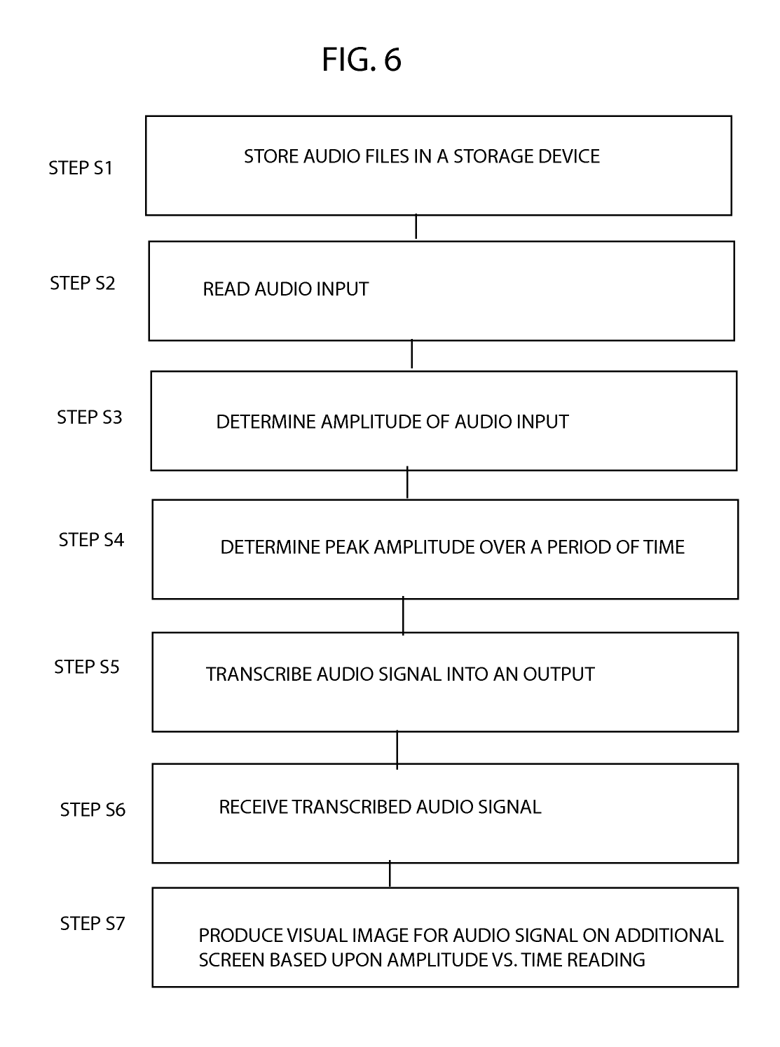

FIG. 6 shows a flowchart for controlling the system as disclosed in FIGS. 1A-4. For example, as shown in this view, there is shown that in step S1 the audio files can be stored either in memory 1201a or in memory 1131. These audio files can be in the form of music audio files which can be in the forms of individual songs. Next, in step S2, the audio input is read by audio transcriber 1100a. Next, in step S3, the amplitude of the audio input is determined via processor 1121 as described above. Next, in step S4 the peak amplitude over a period of time is determined. With this step, a period of time such as 0.5 seconds or 1 second is used as a periodic interval to determine a peak amplitude for that time period. Once that peak amplitude is determined, the clock is synchronized to that peak amplitude such that successive time periods are synched to that first peak amplitude. Next, a series of successive peak amplitudes are determined across these time periods to determine a beat, cadence or rhythm. Once this beat is determined, in step S5, processor 1121 can then transform this beat into an input signal which is then passed through output 1141 into an input of the second video driver 1000a or 1000b. This input can be either in a wired manner such as shown in FIG. 2A or via a wireless communication to second video driver 1000b as shown in FIG. 2B, wherein this audio signal is then received into the second video driver as shown in step S6. Next, in step S7, second video driver 1200a or 1200b is configured to produce a visual image based upon the audio input.

Ultimately, the system which can be configured either as an integrated unit or as an external unit that transforms a standard video display screen into a more interactive video display screen which can provide an interactive video environment which allows for an artistic video display.

Accordingly, while at least one embodiment of the present invention has been shown and described, it is to be understood that many changes and modifications may be made thereunto without departing from the spirit and scope of the invention as defined in the appended claims.

What is claimed is:

1. A video display device comprising:
a) a video display;
b) a first video driver for controlling an image on the video display;
c) a second video driver for controlling a separate image on the video display wherein said second video driver is configured to present a different video image on the video display than the first video driver; and
d) at least one audio transcriber, having an output in communication with said second video driver, said at least one audio transcriber comprising at least one input for receiving an audio signal, at least one transcriber element for transcribing said audio signal into an electrical signal; and at least one output for outputting said electrical signal into said second video driver to create a display having images based upon the input into the audio transcriber.

2. The device as in claim 1, wherein said video display comprises a matrix, wherein said matrix comprises at least a first set of lines and at least a second set of lines forming said matrix, wherein said first set of lines and said second set of lines form a plurality of intersections with each intersection of said first set of lines and said second set of lines forming a video address, wherein said first video driver is in communication with, and is configured to create a display at a plurality of video addresses of said matrix.

3. The device as in claim 2, wherein said second video driver is in communication with a plurality of video addresses of said matrix and is configured to create a display at said plurality of video addresses.

4. The device as in claim 3, wherein said second video driver is in communication with a plurality of video addresses that are separate from said plurality of video addresses in communication with said first video driver.

5. The device as in claim 1, further comprising at least one memory, wherein said memory is configured to store audio files and wherein said memory is in communication with said at least one audio transcriber.

6. The device as in claim 5, wherein said at least one audio transcriber further comprises a microprocessor, wherein said microprocessor is configured to process signals received by said audio transcriber and to also retrieve audio files from said memory.

7. The device as in claim 6, wherein said at least one audio transcriber further comprises an additional memory, wherein said additional memory is configured to store a program which provides instructions to said microprocessor to perform at least one of the following steps: retrieving audio files for play by an audio receiver; determining an amplitude of an audio signal; determining a peak amplitude of said audio signal; determining a peak amplitude across a period of time of said audio signal; providing an output electrical signal based upon said audio signal.

8. The device as in claim 2, further comprising at least one additional video matrix separate from said first video matrix, wherein said second video matrix comprises a plurality of lines forming a plurality of intersections, wherein each intersection of said plurality of lines forms a video address.

9. The device as in claim 8, wherein said second video driver is in communication with said at least one additional video matrix.

10. The device as in claim 8, wherein said at least one additional video matrix comprises at least four additional video matrices.

11. The device as in claim 8 wherein at least one of said at least four additional video matrices is positioned in a corner region of said video display.

12. The device as in claim 9, further comprising a housing for housing said video display, and a least one additional housing for housing said at last one additional video matrix.

13. The device as in claim 12, wherein said at least one additional housing further comprises a coupling element for coupling said at least one additional housing to said housing for said video display.

14. The device as in claim 13, further comprising an electronics housing, wherein said electronics housing is configured to house said second video driver and said audio transcriber.

15. The device as in claim 14, further comprising at least one communication line coupling said at least one additional housing to said at least one electronics housing.

16. The device as in claim 15, further comprising at least one remote control, wherein said at least one remote control is configured to control said at least one first video driver and said at least one second video driver.

17. The device as in claim 16, wherein said at least one remote control comprises at least a first set of buttons for controlling said first video driver, at least a second set of buttons for controlling said second video driver and at least one additional button for controlling said at least one audio transcriber.

18. The device as in claim 17, wherein said at least one first video driver comprises a static flat light setting and said at least one remote control comprises at least one button to control a brightness of said static flat light setting to control an illumination of light in a room.

19. The device as in claim 18, wherein said at least one remote control further comprises at least one button to control a brightness of a display of said second video driver.

20. The device as in claim 1, wherein said second video driver further comprises a memory, a processor, and addressable circuitry so that said second video driver is locatable on a computer network.
